(19) United States
(12) Patent Application Publication
(10) Pub. No.: US 2022/0215452 A1
(43) Pub. Date: Jul. 7, 2022

(54) SYSTEMS AND METHOD FOR GENERATING MACHINE SEARCHABLE KEYWORDS

(71) Applicant: COUPANG CORP., Seoul (KR)

(72) Inventors: Andrei ALIKOV, Seoul (KR); BoWon NAM, Seoul (KR); Ikhan RYU, Gyeonggi-do (KR); SeongJong JEON, Seoul (KR)

(73) Assignee: COUPANG CORP.

(21) Appl. No.: 17/141,791

(22) Filed: Jan. 5, 2021

(51) Int. Cl. G06Q 30/06; G06F 16/583; G06F 16/25; G06F 16/22; G06N 20/00

(52) U.S. Cl. CPC G06Q 30/0627; G06Q 30/0643; G06N 20/00; G06F 16/258; G06F 16/22; G06F 16/583

(57) ABSTRACT

A method for filtering products based on images, comprising the steps of: receiving, from one or more databases, data relating to a product, the information include at least an image, a product identifier, and a context; generating a plurality of fields based on the context; selecting, for each of the plurality of fields, a machine learning model from a plurality of machine learning models; analyzing the data using the selected machine learning model; generating, for each of the plurality of fields, a keyword based on the analysis of the data; updating the data to include the plurality of fields each containing a generated keyword; and indexing the updated data for storage in the one or more databases.

### TECHNICAL FIELD

The present disclosure generally relates to computerized systems and methods for generating machine searchable keywords. In particular, embodiments of the present disclosure relate to inventive and unconventional systems relate to generating machine searchable keywords for data entries stored in databases.

### BACKGROUND

In the field of on-line retail business, information relating to a variety of products are stored in databases. When a shopper browses display interfaces of the on-line retail business, server systems retrieve this information from the databases for display to the shopper. It is typical for the shopper to conduct searches for products by providing to the server systems, search strings. The search strings may include terms relating to brand name, generic name, model name, number, color, year, category, or other attributes that the shopper may associate with a product. The server systems may look for entries in the databases corresponding to products that match one or more of the terms in the search strings. When matches are found, the entries of the corresponding matched products are return in a result list to be displayed to the shopper.

Thus, the quality of the results (i.e. relevancy of the results to the shopper's search) may largely depend on whether database entries of products contain sufficient relevant keywords such that the shopper's search string would likely result in correct matches. For example, a product having a database entry with few keywords are unlikely to be found in a shopper's search, even if it is highly relevant to the search.

Existing methods and systems rely on human individuals to provide such keywords in the database for the entries of the products. This is inefficient, and can be impractical if the number of database entries is large. Moreover, updates to the entries to add or remove keywords may be prohibitively costly if human interventions are required for each entry. Therefore, there is a need for improved methods and systems with to ensure that keywords are generated and updated automatically without human interventions.

### SUMMARY

One aspect of the present disclosure is directed to a method for a method for filtering products based on images, comprising the steps of: receiving, from one or more databases, data relating to a product, the information include at least an image, a product identifier, and a context; generating a plurality of fields based on the context; selecting, for each of the plurality of fields, a machine learning model from a plurality of machine learning models; analyzing the data using the selected machine learning model; generating, for each of the plurality of fields, a keyword based on the analysis of the data; updating the data to include the plurality of fields each containing a generated keyword; and indexing the updated data for storage in the one or more databases.

Another aspect of the present disclosure is directed to a computerized system comprising: one or more processors; memory storage media containing instructions to cause the one or more processors to execute the steps of: receiving, from one or more databases, data relating to a product, the information include at least an image, a product identifier, and a context; generating a plurality of fields based on the context; selecting, for each of the plurality of fields, a machine learning model from a plurality of machine learning models; analyzing the data using the selected machine learning model; generating, for each of the plurality of fields, a keyword based on the analysis of the data; updating the data to include the plurality of fields each containing a generated keyword; and indexing the updated data for storage in the one or more databases.

Yet another aspect of the present disclosure is directed to a system for generating text strings, comprising: receiving, from one or more databases, data relating to a product, the information include at least an image, a product identifier, and a context; generating a plurality of fields based on the context, the plurality of fields comprising at least a brand, one or more attributes, and a product type; selecting, for each of the plurality of fields, a machine learning model from a plurality of machine learning models for analysis of the data, the analysis comprising: analyzing the product identifier using at least one of a text classifier or a rule based extractor; and analyzing the image using at least one of an image OCR or an image classifier. generating, for each of the plurality of fields, a keyword based on the analysis of the data, the keyword being at least one of: a predefined term associated with one of the plurality of fields, or a text extracted from the image by the analysis of the data; updating the data to include the plurality of fields each containing a generated keyword; and indexing the updated data for storage in the one or more databases.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Detail Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 is a diagrammatic illustration of an exemplary system for generating text strings, consistent with the disclosed embodiments.

FIG. 4 is a diagrammatic illustration of an exemplary data representing unrefined and refined product information, consistent with the disclosed embodiments.

FIG. 5 is a flow chart depicting an exemplary process for generating text strings, consistent with the disclosed embodiments.

FIG. 6 depicts an exemplary embodiment of text string generation, consistent with the disclosed embodiments.

FIG. 7 depicts another exemplary embodiment of text string generation, consistent with the disclosed embodiments.

FIG. 8 is a flow chart depicting an exemplary process for generating updates to databases, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

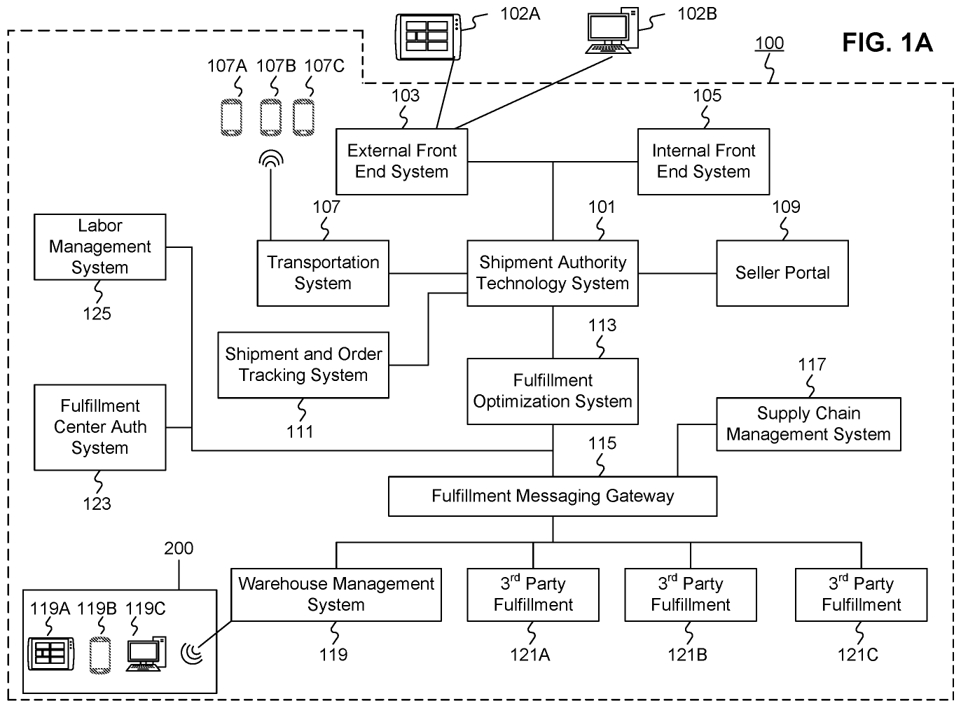

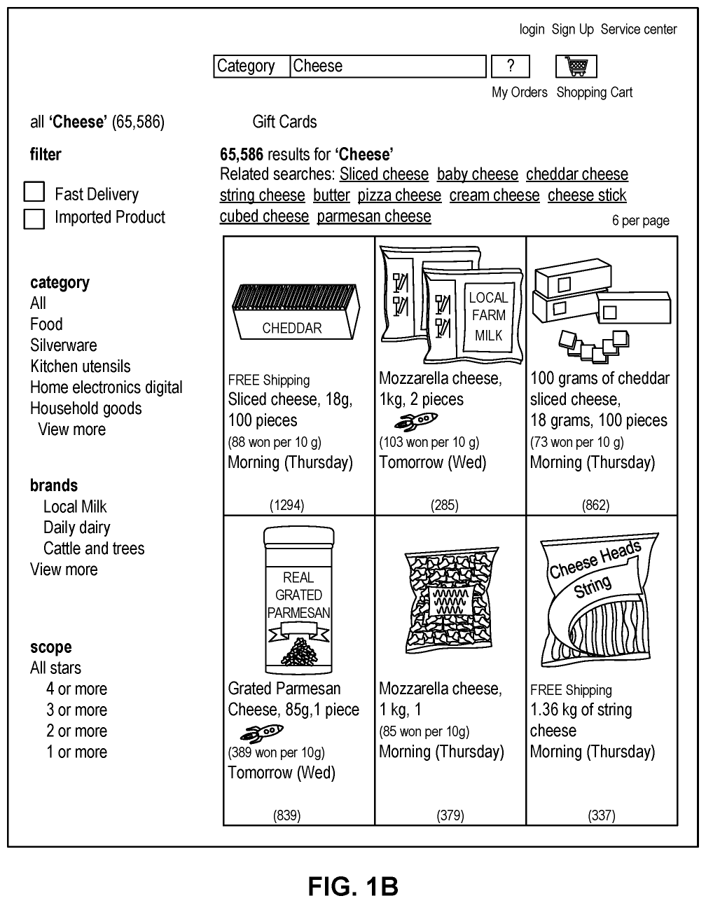

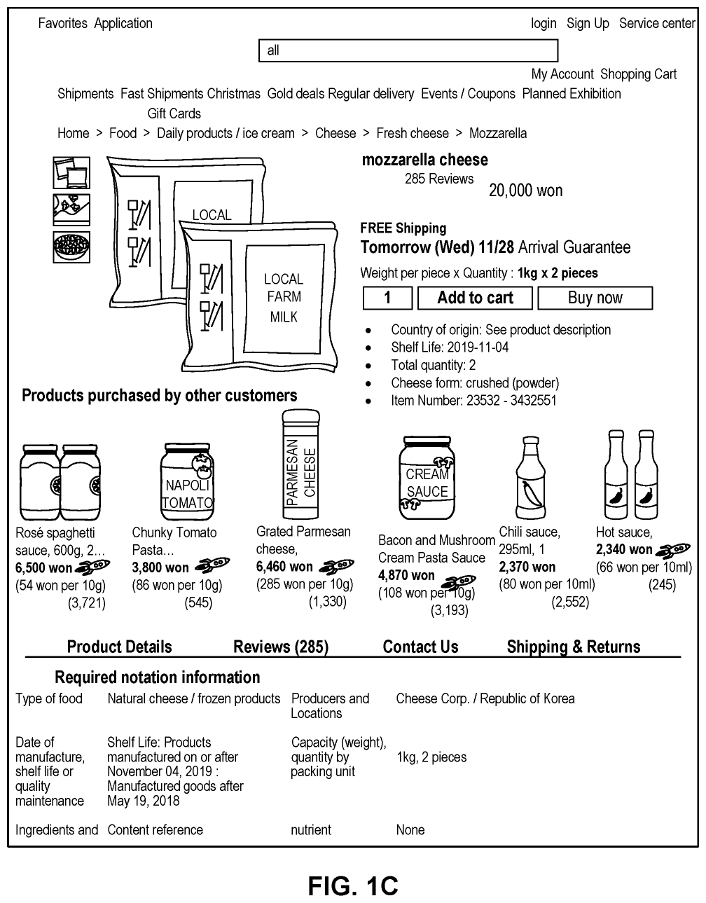

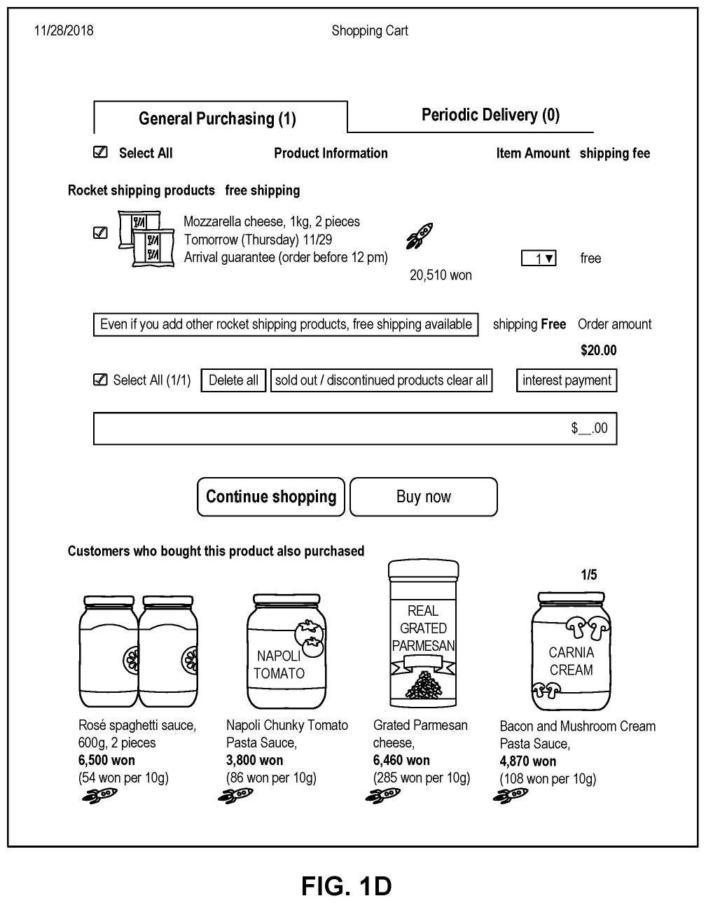

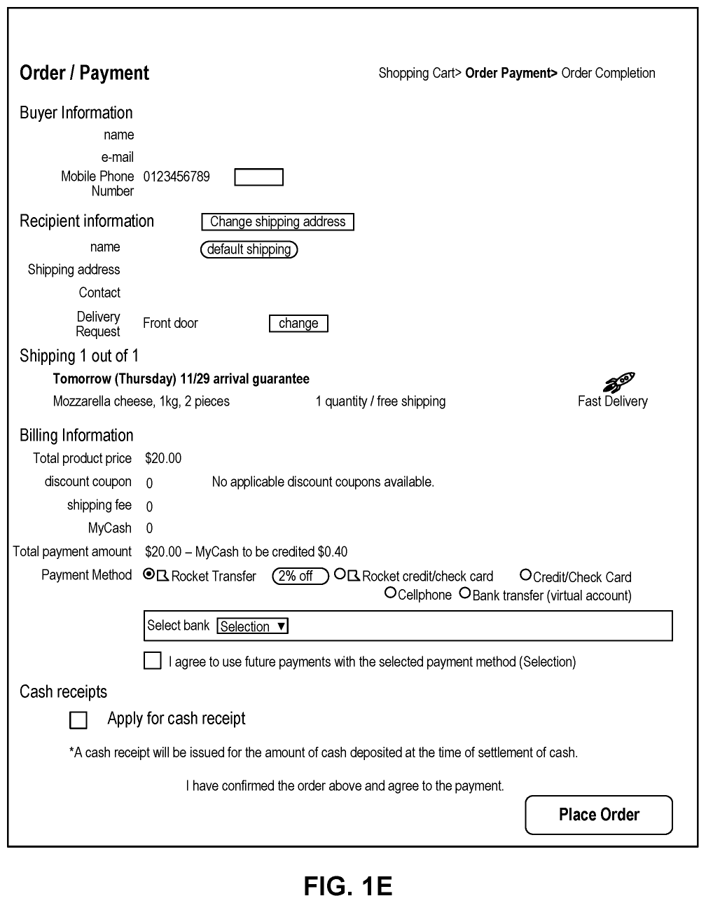

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

The user device may enter information on the Order page and click or otherwise interact with a user interface element that sends the information to external front end system 103. From there, external front end system 103 may send the information to different systems in system 100 to enable the creation and processing of a new order with the products in the shopping cart.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where system 100 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

In some embodiments, FO system 113 may determine a PDD for each product on a periodic basis (e.g., hourly) and store it in a database for retrieval or sending to other systems (e.g., external front end system 103, SAT system 101, shipment and order tracking system 111). In other embodiments, FO system 113 may receive electronic requests from one or more systems (e.g., external front end system 103, SAT system 101, shipment and order tracking system 111) and calculate the PDD on demand.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3^{rd} party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

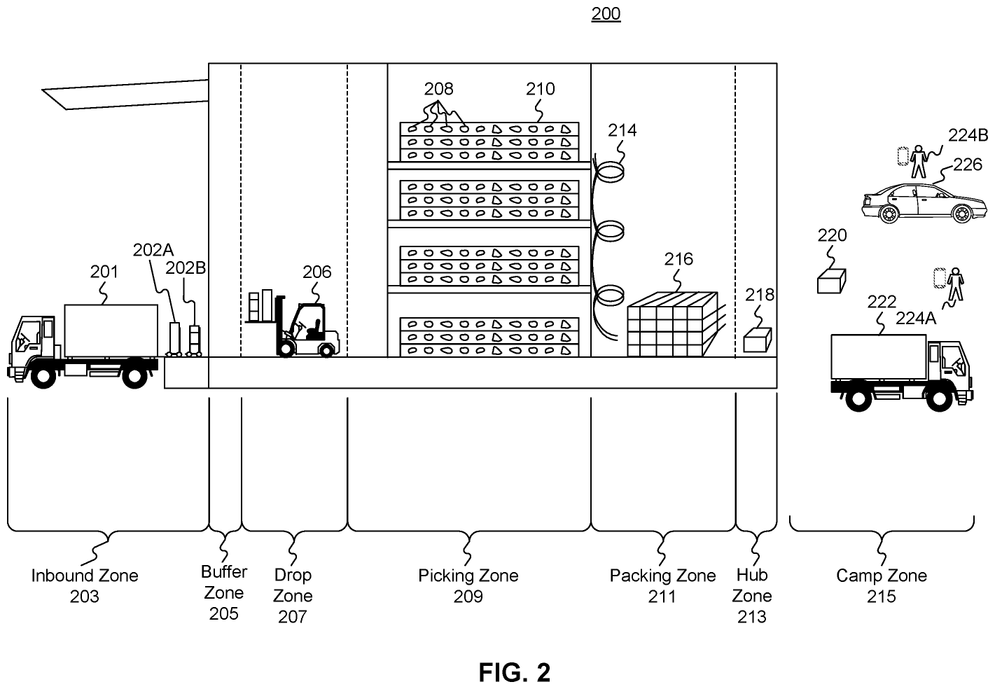

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3^{rd} party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMS 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 1196 to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

According to some embodiments, there are provided methods for generating text strings. Text strings, in context of computer technology, may refer to a series of data bits that represent characters such as letters, numbers, punctuations, and/or other similar information. In some embodiments, searchable keywords may be in the form of text strings. According to some embodiments, there are provided systems for generating text strings, the systems include one or more processors and one or more memory storage media.

According to some embodiments, the systems may receive, from one or more databases, information relating to a product, the information include at least an image, a product identifier, and a context. As described previously, products may be associated with product information, which may include images or pictures. An image, as used here, may be a visual representation of a product, its features, use, and/or other properties. Examples of an image include a drawing, a picture, a photo, a graphic, an animation, a cartoon, an illustration, an icon, and/or other visual elements. A product identifier may be data that uniquely identifies a product stored in a database. For example, a product identifier may include serial number, tag, stock keeping unit, name, code, and/or other identifying information. Various different information relating to the same product may be linked via the product identifier when stored in the database. In some embodiments, the product identifier may be the name or title of the product. In some embodiments, the information may include specifications relating to a product. Specifications may refer to information in text forms that describes one or more properties of a product, such as its dimension, weight, color, or any such information that may be relevant to some aspects of a product.

Context may refer to information that aid in categorizing or assigning properties to a product. In some embodiments, the specification is context dependent. For example, a laptop may include specifications such as screen size, weight, battery life, memory, processing speed, etc. In another example, a TV may include specifications such as type of display (plasma/LED/LCD), resolution, output interface, power consumption, etc. In yet another example, a toy comprised of interlocking plastic bricks may include specification such as number of pieces, material, suggested age of user, etc. A person of ordinary skill in the art will appreciate that other examples of products belonging to different categories may include other type of information. In some embodiments, the context is a category of the product. Examples of categories may include, but not limited to, apparels, toys, lap-top computers, mobile phones, fresh food, books, containers, and other similar categories of item often associated with retail businesses.

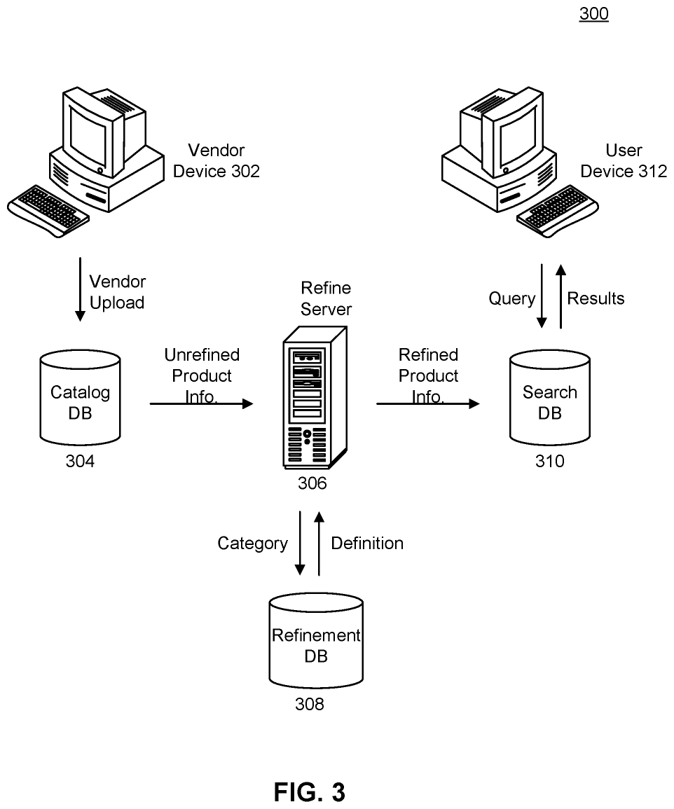

By way of example, FIG. 3 depicts diagrammatic illustration of an exemplary system generating text strings, consistent with the disclosed embodiments. System 300 may include vendor device 302. Vendor device 302 may be a computing device that uploads data to a database, such as catalog DB 304. In some embodiments, data uploaded from vendor device 302 are related to products, and they are stored as entries in catalog DB 304. In some embodiments, user devices 102A-C may be examples of vendor device 302, and external front end system 103 may interact with user devices 102A-C to configure the uploaded data for storage as entries in catalog DB 304. In some embodiments, vendor device 302 may be associated with a vendor who is the source of the product (e.g., a manufacturer or reseller) for sale on system 100. For example, the vendor who provide a product for sale on system 100 may provide (i.e. upload) information of the product to a database (e.g. catalog DB 304), these information may include product name, color, brand, category, other specifications (e.g. size, dimension, color, battery life), images, and/or other features and options that inform potential buyers of the product's nature and use.

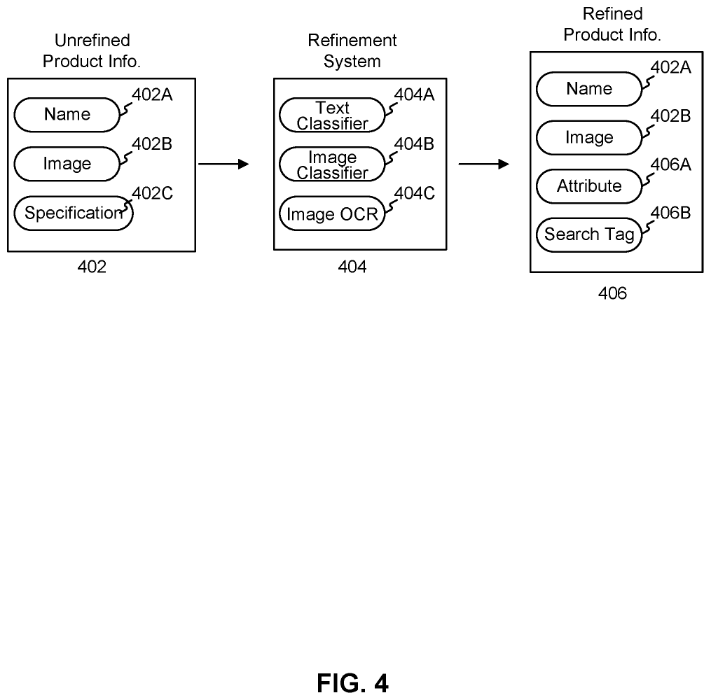

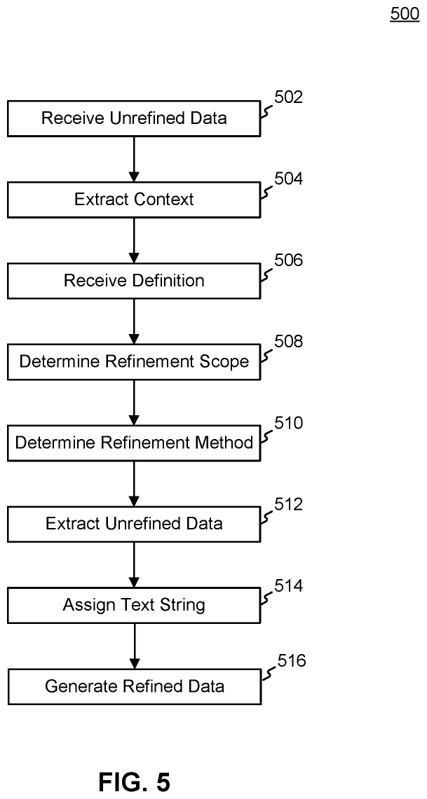

Server 306 may be a computing device including one or more processors, I/O sections, and memory storage media. Server 306 may retrieve, as inputs, data from entries in a first database, such as catalog DB 304, and may provide as output, processed data for storage in a second database, such as search DB 310. In some embodiments, data retrieved from catalog DB 304 may be unrefined data relating to a product, and data provided to search DB 310 may be refined data relating to the product. The refined and unrefined data, as well as the refinement process will be described below with reference to FIG. 4 and FIG. 5. In some embodiments, server 306 may provide portions of unrefined data to a third database, such refinement DB 308, and retrieve in response, a definition from refinement DB 308. In some embodiments, the portions of unrefined data provided to a third database may include a context of the unrefined data, and server 306 utilizes the definition during the refinement process for generating the refined data, details of which will be described below with reference to FIG. 4 and FIG. 5.

User device 312 may be a computing device associated with users who may be interacting with system 100 as shoppers. User devices 102A-C may be examples of user device 312. In some embodiments, shoppers using user device 312 may perform searches for products, and entries in databases such as search DB 310 matching the criteria of the search (or query) may be returned as results to user device 312. In some embodiments, user device 312 may interact with front end system 103 to perform searches in search DB 310. In some embodiments, an entry in search DB 310 corresponding to a product may differ from an entry in catalog DB 304 corresponding to the same product. For example, entries in CDS DB 304 may be unrefined product information, and entries in search DB 310 may be refined product information. Server 306 may transform the unrefined product information to refined product information.

By way of example, FIG. 4 is a diagrammatic illustration of an exemplary unrefined and refined product information, consistent with the disclosed embodiments. The information relating to a product may be unrefined product information, exemplified as data block 402. In some embodiments, data block 402 represents the entry in catalog DB 304 corresponding to a product, including name 402A, image 402B, and specification 402C as described above. Information contained in data block 402 may be supplied from vendor device 302 associated with a vendor of the product. In some embodiments, information contained in data block 402 may be uploaded via vendor device 302 to catalog DB 304 as the vendor registers the product for sale on system 100, or as the vendors updates information of a previously registered product. Alternatively, or additionally, in some embodiments, an operator may provide refinement logic or product information to aid system 300. For example, an operator may preview results of refinement, and adjust setting and/or logic to optimized system results.

Refinement system 404 may be a computerized system for transforming data block 402 into data block 406. In some embodiments, refinement system 404 is implemented by server 306 of FIG. 3. Refinement system 404 may include one or more machine learning models, such as text classifier 404A, image classifier 404B, and/or image OCR 404C. Operation of refinement system 404 (and server 306) are described in detail below.

Data block 406 represent product information stored as an entry in a database, such as search DB 310. In some embodiments, data block 406 includes name 402A, image 402B, attribute 406A, and search tag 406B. Name 402A and image 402B may be extracted from data block 402, while attribute 406A and search tag 406B may be generated by refinement system 404.

By way of example, FIG. 5 depicts a flow chart depicting an exemplary process for generating text strings, consistent with the disclosed embodiments. In step 502, server 306 receives unrefined data. In some embodiments, the unrefined data may be data block 402 containing name 402A, image 402B, and specification 402C as described above.

According to some embodiments, the systems may generate a plurality of fields based on the context. In some embodiments, “field” may refer to a data field, such as a component of data of a database entry. In some embodiments, the generated fields are that of the refined product information. In some embodiments, each of the plurality of fields is a predefined data field corresponding to an aspect of the product. For example, each of the fields may correspond to an attribute. In some embodiments, the plurality fields include at least one of a brand, an attribute, or a product type. For example, for a given product, the database entry may include at least a field for the product's brand, at least one attribute, and the product's type, respectively.

In step 504, after receiving unrefined data, server 306 extracts a context from the unrefined data. The context may be the product type or category as described previously. The product type may be the category to which the product belongs. For instances, if the product is a laptop computer, the systems may generate a field to include data corresponding to its brand (e.g. Apple, Dell, Lenovo, etc.); at least one field to include data corresponding to at least one attribute (e.g. screen size, weight, processor speed, memory, battery life, etc.); and a field to include data corresponding to its product type (e.g. personal computing devices). A person of ordinary skill in the art will appreciate that the systems may generate additional fields as appropriate to the product type. In some embodiments, the plurality of fields for a product may be predetermined based the product type. For example, “mobile computing devices” may be a product that that has been predetermined in the systems to have a field for screen size, weight, processor speed, memory, battery life, or other predetermined attribute as designed by the systems. In some embodiments, the relationship between the plurality fields to be generated for a product and its product type may be stored in as a file in a database, and the systems may retrieve this file prior to generating the plurality of fields.

By way of example, as depicted in FIG. 3, server 306 provide “category” to refinement DB 308, and retrieve “Definition” from refinement DB 308. Category may be an example of the product type, and definition may be an example of the file instructing server 306 for generating the plurality of fields.

In step 506, server 306 determines the refinement scope. In some embodiments, server 306 determines the refinement scope by generating the plurality of fields for the product. Since each field requires refinement, the fields that are generated thus defines the scope of the refinement operation. As described above with reference to FIG. 4, server 306 generates the plurality field based on the product type/category of the product. In some embodiments, server 306 provides the extracted context (e.g. product category/type) to a database such as refinement DB 308, and retrieve a file (e.g. definition) that defines the what fields are to be generated and the manner of generation based on the extracted context. In step 506, server 306 generates the plurality of fields based on the retrieved file.

According to some embodiments, the system may select, for each of the plurality of fields, a machine learning model from a plurality of machine learning models. Machine learning models may refer to computer software, programs and/or algorithms that are capable of carrying out tasks without specifically being instructed or programmed to do so. Examples of machine learning models include neural networks, decision trees, regression analysis, Bayesian networks, genetic algorithms, and/or other models configured to train on some training data, and is configured by the training to process additional data to make predictions or decisions. In some embodiments, the systems may possess multiple machine learning models, and the systems may determine one of these machine learning models for use for a specific field. The plurality of machine learning models may be trained using pre-built data set containing relevant images.

In step 510, server 306 determines refinement method for each of the plurality of fields. The refinement methods may be one of the machine learning models such as text classifier 404A, image classifier 404B, or image OCR 404C as depicted in FIG. 4. In some embodiments, each of the plurality of fields is associated with one of the plurality of machine learning model, and a library containing a plurality of text strings. In some embodiment, the associations of the fields, the machine learning models, and the library containing the text strings may be predetermined and stored in a file on a database. By way of example, as depicted in FIG. 3, refinement DB 308 may store definition, which may be an example of the file. The definition may include the associations of the fields, the machine learning models, and the library containing the text strings. Definition may further describe, for each field, the appropriate machine learning model for use, and a list of text strings appropriate to the field.

According to some embodiments, the systems may analyze the information using the selected machine learning model. In step 512, the systems extract the unrefined data. For example, for each of the plurality of field generated, using one of the machine models selected in step 510, the systems analyze the information associated with the product. Based on this analysis, the systems also generate a keyword for each of the field.

In some embodiments, the selected machine learning model is an image classifier; and analyzing the information comprises analyzing the image. An image classifier may refer to programs, algorithms, logic, or code for determining one or more aspect or attribute of an image. The image classifier may assign to an image one or more classes, a class being a pre-defined property of the image. Using a trained neural network, the image classifier may attempt recognize some features of an image, and assign a class to the image based on the output of the neural network. A neural network, or artificial neural network, may refer to a type of machine learning model which input data are provided to layers of networked nodes, which in turn provide output data. Within the layers, the networked nodes are connected via network connections which are ‘weighted.” Input data may be processed by one or more of these networked nodes, passing through these weighted connections. The weights of the weighted connections may be determined by a learning rule. A learning rule may be a logic for assigning a weight to each of the connection of a networked node. For example, the learning rule may be relations contained in a set of training data including pre-labeled input and output data. A neural network may thus be “trained” to recognize the relationship between pre-labeled input and output data by to assigning weights to the connections between the networked nodes in the layers. Once trained, using the established weighted connections between the networked nodes, the neural network may process additional input data to produce desired output data.

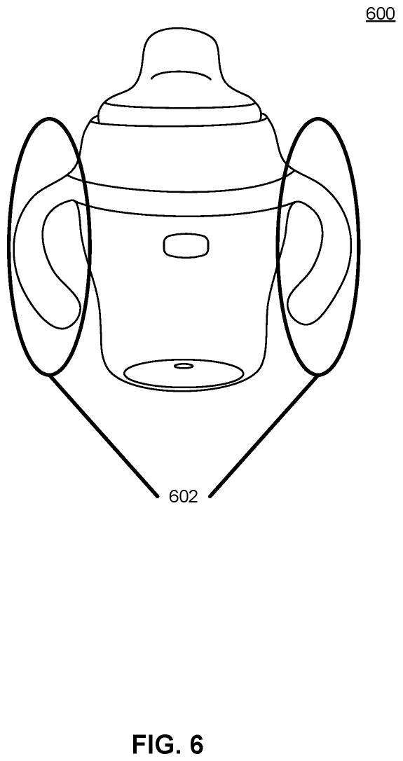

By way of example, server 306 may contain machine learning image classifiers, such as image classifier 404B. Based on the definition retrieved from refinement DB 308, server 306 determines that a particular field requires analysis using image classifier 404B. Moreover, based on the definition retrieved from refinement DB 308, server 306 determines that a particular field is associated with a particular list of text strings, which may be included or defined in the definition. By way of example, as depicted in FIG. 6, a product may be a water cup. Information relating to the water cup may include image 600, which is an image of the water cup. Server 306 may generate a plurality of fields for the water cup, one of the fields may be “a number of handles.” In this example, a definition for this product type may predetermine that image classifier should be used to analyze information for this field.

In some embodiments, image classifier 404B is the neural network model which consists of a number of convolutional layer (e.g., 13) and a number of fully connected layers (e.g., 3) of neural networks. In some embodiments, image classifier 404B uses a 3×3 convolution filter and 2×2 max pooling layers, utilizing a rectified Linear Unit (ReLU) as an activation function of each neural node. In some embodiments, image classifier 404B may be configured to only activate on images from specific categories and attributes. For example, image classifier 404B uses four classes as a prediction result such as “two-handed”, “one-handed”, “no-handed”, “not a target image” and “not a target image” in order to identify related or non-related images (e.g., only selecting water cup images as target for image classifier 404B when identifying a number of handle).

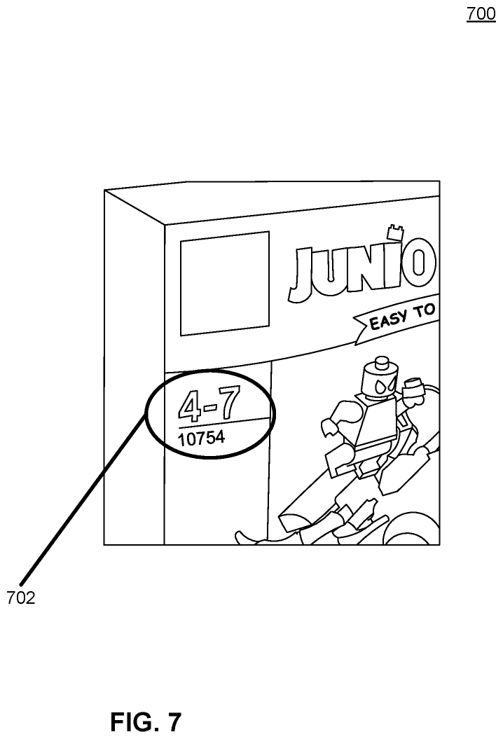

In some embodiments, the selected machine learning model comprises an image OCR algorithm; and analyzing the data comprises analyzing the image. An image OCR (optical character recognition) may refer to programs, algorithms, logic, or code for extracting text characters from an image. By way of example, server 306 may contain machine learning image OCR, such as image OCR 404C. Based on the definition retrieved from refinement DB 308, server 306 determines that a particular field requires analysis using image classifier 404C. By way of example, as depicted in FIG. 7, a product may be a plastic brick assembling toy for children. Information relating to this toy may include image 700, which is an image of the toy packaging. Server 306 may generate a plurality of fields for this toy, one of the fields may be “suggested age.” In this example, a definition for this product type may predetermine that image OCR should be used to analyze information for this field.

In some embodiments, the selected machine learning model is a text extractor. A text extractor may refer to programs, algorithms, logics, or codes for extracting text characters from data supplied. In some embodiments, the text extractor is at least one of a rule based extractor or a text classifier, and analyzing the data comprises analyzing the product identifier. A rule based extractor may refer to text extractor that operate on predefined rules. A text classifier may refer to machine learning model that classifies, tags, or otherwise categorizes data supplied based on machine learning process rather than predefined rules. A product vendor may supply the product identifier in form of text characters. In some embodiments, the text classifier may be a natural language processor.

By way of example, server 306 may contain machine learning text extractor, such as text classifier 404A. Based on the definition retrieved from refinement DB 308, server 306 determines that a particular field requires analysis using text classifier 404A. In some embodiments, text classifier 404A may include a rule based text extractor configured to extract certain predefined texts. For example, if a product is a water cup, information relating to the water cup may include the product identifier (e.g. product name). Server 306 may generate a plurality of fields for the water cup, one of the fields may be “BPA Status.” In this example, a definition for this product type may predetermine that a rule based text extractor should be used to analyze information for this field, such that text character match “BPA” may be filtered. In some embodiments, text classifier 404A may include a natural language processor. For example, if a product is a lap-top, information relating to the lap-top computer may include specifications provided by the vendor (e.g. processor speed). Server 306 may generate a plurality of fields for the lap-top computer, one of the fields may be “processor speed.” In this example, a definition for this product type may predetermine that a natural language processor should be used to analyze information for this field, such that attributes relating to processor speed of the lap-top computer may be extracted from the specification of the product.

According to some embodiments, the systems may generate, for each of the plurality of fields, a keyword based on the analysis of the information. By way of example, in step 514, the systems assign text string to each of the fields based on the analysis, and the text string being part of the definition retrieved in step 506.

In some embodiments, generating the keyword include selecting, for each of the plurality of fields generated, one of the plurality of text strings from the associated library based on the analysis of the image. By way example, after server 306 analyzes images associated with a product using image classifier 404B, server 306 select one of the text strings from the list of text strings associated with the field. As depicted in an example in FIG. 6, in the example where the product a water cup, and image 600 is analyzed by image classifier 404B. Server 306 may determine that image 600 has features 602 indicating 2 handles. Thus the analysis by image classifier may conclude that the water cup has 2 handles. Server 306 may then select a text string “2” among the list of text strings, and thus may assign to the field “number of handle” the text string “2.”

By way of another example, after server 306 analyzes images associated with a product using image classifier 404C, server 306 select one of the text strings from the list of text strings associated with the field. As depicted in an example in FIG. 7, in the example where the product is plastic toy bricks, and image 700 is analyzed by image OCR 404C. Server 306 may extract from image 700, label 702, indicating a suggested age. Thus image OCR 404C may determine from the analysis that the plastic toy bricks has a suggested age of “4-7.” Server 306 may then select a text string “4-7” among the list of text strings, and thus may assign to the field “suggested age” the text string “4-7.”

In some embodiments, generating the keyword includes generating, for each of the plurality of fields generated, a text string based on the analysis of the product identifier. By way example, after server 306 analyzes the product identifier using text classifier 404A, server 306 may extract text strings from the product identifier and assign this text string to the corresponding field, or otherwise assigns a predetermined text string to the field. For instances, is the product identifier (i.e. name) contain the working such as “BPA free” or “no BPA,” server 306 may assign the field for “BPA status” a text string indicating that the product is free of plastic BPA. In another instance, since the product identifier often contain a brand name, server 306 may assign the field corresponding to “Brand,” text string exacted from the product identifier, such as “Apple” from “Apple Watch,” or “Dell” from “Dell laptop computer.”

According to some embodiments, the systems may update the information to include the plurality of fields each containing a generated keyword. By way of example, data block 406 depicted in FIG. 4 may be an example of updated information of a product. In addition to name 402A and image 402B, which are information contained in data block 402, data block 406 include attribute 406A and search tag 406B. In some embodiments, attribute 406 may represent the plurality of fields with assigned text strings. The number of fields in attribute 406 may be defined by definition, and is based on the product type/category of the product.

According to some embodiments, the systems may index the updated information for storage in the one or more databases. By way of example, as depicted in FIG. 3, server 306 provides refined product information (e.g. data block 406) to be stored in search DB 310 as an entry representing a product.

In some embodiments, the systems may receive, from a client device, a search query containing a search string. A search query may refer to a command or instruction to perform a search. The search query may contain data for which the systems attempts to find a match, such data may be in the form of a text string.

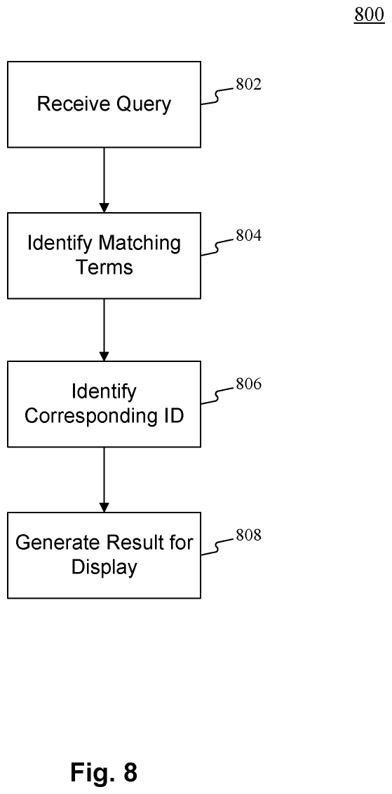

FIG. 8 is a flow chart depicting an exemplary process for generating updates to databases, consistent with the disclosed embodiments. In step 802, external front end system 103 receive a query. By way of example, as depicted in FIG. 3, user device 312 may transmit a query to search through entries in search DB 310. In some embodiments, external front end system 103 may process the query and send it to search DB 310. Searches may be performed by search algorithms or engines, and may be carried out by one or more sub-system of system 100, such as external front end system 103.

In some embodiments, the systems may determine that one or more keywords in the plurality of fields of the updated data match the search string. In step 804, external front end system 103 may identify matching terms in database entries match the query. By way of example, external front end system 103 may search for entries in search database 310 matching the query.

In step 806, external front end system 103 may identify product identifier corresponding to the matched entries determined in step 804. In some embodiments, external front end system 103 may attempt to match the search string contained in the query to one more of search tag 406B contained in the entries stored in search DB 310 representing products.

In some embodiments, the systems may retrieve the information corresponding to the match for display on the client device. In step 808, external front end system may generate results for display on user devices, the results may include one or more of the product identifiers of identified in step 808. By way of example, external front end system 103 may return results to user device 312. The results may include entries of search DB 310 having search tag 406B matching the query. In some embodiments, the results may be displayed as SRP as depicted in FIG. 1B.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. A computer-implemented method for generating text strings, comprising:
receiving, by a processor, from one or more databases, data relating to a product, the data including at least an image, a product identifier, and a context, wherein the context includes a product specification;
generating, by the processor, a plurality of fields based on the product type;
selecting, by the processor, for each of the plurality of fields, a machine learning model from a plurality of machine learning models and the data for feeding to the selected machine learning model;
analyzing, by the processor, for each of the plurality of fields, the selected data using the selected machine learning model;
generating, by the processor, for each of the plurality of fields, a keyword based on the analysis of the selected data;
updating, by the processor, the data to include the plurality of fields each containing a generated keyword to produce refined data; and
indexing, by the processor, the refined data for storage in the one or more databases.

2. The method of claim 1, further comprising:
receiving, from a client device, a search query containing a search string;
determining that one or more keywords in the plurality of fields of the refined data match the search string; and
retrieve the data corresponding to the match for display on the client device.

3. The method of claim 1, wherein each of the plurality of fields is a predefined data field corresponding to an aspect of the product; and wherein each of the plurality of fields is associated with one of the plurality of machine learning model, and a library containing a plurality of text strings.

4. The method of claim 3, wherein the selected machine learning model is an image classifier; and
analyzing the selected portion of the data comprises analyzing the image;
generating the keyword comprises:
selecting, for each of the plurality of fields generated, one of the plurality of text strings from the associated library based on the analysis of the image.

5. The method of claim 3, wherein the selected machine learning model is an image OCR; and
analyzing the selected portion of the data comprises analyzing the image;
generating the keyword comprises:
generating, for each of the plurality of fields generated, a text string based on the analysis of the image.

6. The method of claim 3, wherein the selected machine learning model is a text extractor; and
analyzing the selected portion of the data comprises analyzing the product identifier; generating the keyword comprises:
generating, for each of the plurality of fields generated, a text string based on the analysis of the product identifier.

7. The method of claim 1, wherein the text extractor is at least one of a rule based extractor or a text classifier.

8. The method of claim 1, wherein the context further includes a category of the product.

9. The method of claim 1, wherein the product identifier is the name or title of the product.

10. The method of claim 1, wherein the plurality fields comprises at least a brand, an attribute, a product type.

11. A system for generating text strings, comprising:
one or more processors;
memory storage media containing instructions to cause the one or more processors to execute the steps of:
receiving, from one or more databases, data relating to a product, the data including at least an image, a product identifier, and a context, wherein the context includes a product specification;
generating a plurality of fields based on the product type;
selecting, for each of the plurality of fields, a machine learning model from a plurality of machine learning models and a portion of the data for feeding to the selected machine learning model;
analyzing, for each of the plurality of fields, the selected data using the selected machine learning model;
generating, for each of the plurality of fields, a keyword based on the analysis of the selected data;
updating, by the processor, the data to include the plurality of fields each containing a generated keyword to produce refined data; and
indexing, by the processor, the refined data for storage in the one or more databases.

12. The system of claim 11, further comprising executing the steps of:
receiving, from a client device, a search query containing a search string;
determining that one or more keywords in the plurality of fields of the refined data match the search string; and
retrieve the data corresponding to the match for display on the client device.

13. The system of claim 11, wherein each of the plurality of fields is a predefined data field corresponding to an aspect of the product; and wherein each of the plurality of fields is associated with one of the plurality of machine learning model, and a library containing a plurality of text strings.

14. The system of claim 13, wherein the selected machine learning model is an image classifier; and
analyzing the selected portion of the data comprises analyzing the image;
generating the keyword comprises:
selecting, for each of the plurality of fields generated, one of the plurality of text strings from the associated library based on the analysis of the image.

15. The system of claim 13, wherein the selected machine learning model is an image OCR; and
analyzing the selected portion of the data comprises analyzing the image;
generating the keyword comprises:
generating, for each of the plurality of fields generated, a text string based on the analysis of the image.

16. The system of claim 13, wherein the selected machine learning model is a text extractor; and
analyzing the selected portion of the data comprises analyzing the product identifier;
generating the keyword comprises:
generating, for each of the plurality of fields generated, a text string based on the analysis of the product identifier.

17. The system of claim 11, wherein the text extractor is at least one of a rule based extractor or a text classifier.

18. The system of claim 11, wherein the context further includes a category of the product.

19. The system of claim 1, wherein the product identifier is the name or title of the product.

20. A computer-implemented method for generating text strings, comprising:
receiving, by a processor, from one or more databases, data relating to a product, the data including at least an image, a product identifier, and a context, wherein the context includes a product specification;
generating, by the processor, a plurality of fields based on the product type, the plurality of fields comprising at least a brand, one or more attributes, and a product type;
selecting, by the processor, for each of the plurality of fields, a machine learning model from a plurality of machine learning models for analysis of a portion of the data for feeding to the selected machine learning model, the analysis comprising:
analyzing, by the processor, the product identifier using at least one of a text classifier or a rule based extractor; and
analyzing, by the processor, the image using at least one of an image OCR or an image classifier.
generating, by the processor, for each of the plurality of fields, a keyword based on the analysis of the data, the keyword being at least one of:
a predefined term associated with one of the plurality of fields, or
a text extracted from the image by the analysis of the data;
updating, by the processor, the data to include the plurality of fields each containing a generated keyword to produce refined data; and
indexing, by the processor, the refined data for storage in the one or more databases.
